(19) United States
(12) Patent Application Publication
(10) Pub. No.: US 2006/0056826 A1
(43) Pub. Date: Mar. 16, 2006

(54) Lens-fitted photographic film unit

(76) Inventors: Hirofumi Katsura, Kanagawa (JP); Hirokatsu Chuman, Kanagawa (JP); Kazumi Koike, Kanagawa (JP)

Correspondence Address: YOUNG & THOMPSON, 745 SOUTH 23RD STREET, 2ND FLOOR, ARLINGTON, VA, 22202, US

(21) Appl. No.: 11/216,162

(22) Filed: Sep. 1, 2005

(30) Foreign Application Priority Data
Sep. 1, 2004 (JP) 2004-254913

(51) Int. Cl. G03B 9/26

(52) U.S. Cl. 396/6; 396/494

(57) ABSTRACT

A lens-fitted photographic film unit is provided with a cassette chamber for containing a cassette and a film chamber for containing an unexposed photo film drawn from the cassette. The front portion of the cassette chamber is formed of a curved wall which cross section is in a U-shape. A taking lens has a first lens element, a second lens element, and a third lens element that are disposed from the subject side in the stated order. A shutter blade is provided with a light shield portion for opening/closing a photography light path. The light shield position is disposed between the first lens element and the second lens element, such that a part of the light shield portion enters a space formed in front of the cassette chamber when the shutter blade moves from a close position to an open position.

### BACKGROUND OF THE INVENTION

1. Field of the Invention

The present invention relates to a lens-fitted photographic film unit having a preloaded photo film, in particular, to the lens-fitted photographic film unit having a taking lens comprising three or more lens elements.

2. Background Arts

A lens-fitted photographic film unit has been provided heretofore which enable a user to easily take a picture. The lens-fitted photographic film unit has a simple structure and basically comprises a taking lens, a shutter mechanism and an unexposed photo film, while not having mechanisms for automatic focusing and automatic exposing that are normally mounted in a compact camera.

The unexposed photo film is, in advance, drawn from a cartridge (a cassette) and held in a roll shape in a film chamber provided next to one side of an exposure aperture. The cartridge is loaded in a cartridge chamber (a cassette chamber) provided next to the other side of the exposure aperture to contain exposed frames one by one after each shooting. A front face the cartridge chamber is formed of a curved wall having a cross section in U-shape and similar to the periphery of the cartridge. The shutter mechanism is provided with a shutter blade disposed across a photography light path, and the shutter blade swings toward the cartridge chamber against a bias of a spring when kicked by a shutter driving lever.

A well-known type of taking lens is composed of one or two plastic lenses that are able to be mass-produced. A sub-wide angle lens with focal length of, for example, less than 35 mm is employed in the lens-fitted photographic film unit for the photo film of 35 mm in width in the cartridge (135 Type) or the photo film of 24 mm in width in the cartridge (IX240 Type). The sub-wide angle lens not only enables to reduce the thickness of the taking lens but also has a larger f-number of more than 9.5 than that of the taking lens having the same focal length as that in the compact camera. Having a deep depth of field, the lens-fitted photographic film unit with the sub-wide angle lens can obtain sharp image quality in a wide range from a long to a short distance, even having no focusing mechanism.

A high-speed film with wide latitude, such as the one of ISO400 or ISO800, is loaded in the lens-fitted photographic film unit. Recently, a developing system is installed that can print a fine photograph by electrically correct the density of a main subject in a far-overexposed negative. By the system, an image taken by the lens-fitted photographic film without an automatic exposure adjusting device can be printed into a fine picture.

Recently suggested is the lens-fitted photographic film unit using the high speed film such as ISO1600 or ISO3200 instead of mounting the flash device. However, the high speed film is highly likely to cause over exposure in daylight photographing, while it has no problem in indoor photographing. In order to deal with this problem, there is the lens-fitted photographic film unit with a stop changeover mechanism on the market.

Such a lens-fitted photographic film unit with the stop changeover mechanism is, for example, one having a single lens element with a stop disposed behind the lens disclosed in Japanese Patent Laid-Open Publication Number 2002-90793, or the other having two lens elements with the stop disposed between the lens elements disclosed in Japanese Patent Laid-Open Publication Number 2001-215661. The single lens element is a positive meniscus lens with its convex surface on the subject side. The reasons to employ the stop behind the lens are: that the meniscus shape with a concave surface on the stop side has an advantage in compensation of aberration, that it is preferred to dispose the shutter close to the stop in terms of downsizing and efficiency of the lens-fitted photographic film unit, and that it is also preferred to dispose the shutter in a position not to be operated from outside for reliability. Furthermore, the shutter blade is also disposed behind the single lens element, and this has an advantage in being able to keep a long path of the shutter blade by using a space formed around the cartridge chamber of approximate circular shape.

The taking lens comprising two lens elements can have a wider angle. In the lens-fitted photographic film unit disclosed in Japanese Patent Laid-Open Publication Number 2001-215661, a stop plate with a small aperture formed thereon is inserted between the two lens elements and removed therefrom. In addition, a fixed full-opened aperture is disposed behind the taking lens, and the shutter blade is disposed behind the full-opened aperture. On the other hand, there is the lens-fitted photographic film unit capable of changing exposure conditions among three levels by inserting and removing two stop plates having an aperture of different sizes (Japanese Patent Laid-Open Publication Number 2002-49075). This type of the lens-fitted photographic film unit has the taking lens comprising two lens elements including a front lens element and a rear lens element, and a first stop plate is disposed behind the rear lens, while a second stop plate is disposed between the front lens element and the rear lens element. The fixed full-opened aperture is disposed between the rear lens element and the first stop plate, while the shutter blade is disposed behind the first stop plate.

However, the shutter blades are disposed behind the taking lens having two lens elements in the lens-fitted photographic film units in Japanese Patent Laid-Open Publication Number 2001-215661 and Number 2002-49075. Since the taking lens comprising two lens elements requires a larger space than the single lens element and has a short focal length, it is disposed close to the focal-plane. In this case, accordingly, the shutter blade disposed behind the taking lens cannot have a sufficient space for its path, since the widest portion of the periphery of the cartridge chamber interrupts the path.

It is desired to compose the taking lens with three lens components to have a further wider angle and to improve image quality by reducing the aberration caused by having the wider angle. However, the three lens components requires a larger space than the two lens elements and, as a result, the lens element at the rearmost is disposed so close to the focal-plane that the shutter blade cannot have an enough space for its path by the same reason as it disposed behind the two lens components.

### SUMMARY OF THE INVENTION

An object of the present invention is to provide a lens-fitted photographic film unit having a taking lens comprising at least two lens elements, three lens elements in particular, which can employ a conventional shutter mechanism.

In order to achieve the above object and other objects, the lens-fitted photographic film unit of the present invention is provided with a first lens element, a second lens element, and a third lens element disposed from a subject side in the stated order on a photography light path. The shutter blade is provided with a light shield portion for opening/closing the photography light path. The light shield portion is disposed between the first lens element and the second lens element such that a part of the light shield portion enters a space formed in front of a cartridge chamber (a cassette chamber) when the shutter blade moves to an open position.

In addition, the lens-fitted photographic film unit of the present invention satisfies the following conditional expressions: L≧((2+\sqrt{2})/4)×D (mm), and C≧3 (mm), provided that C (mm) represents a distance from the front end of the first lens element to the rear end of the second lens element, D (mm) represents an external diameter of a cartridge (a cassette), and L (mm) represents a distance from a photo film at the center of an exposure aperture to a principal point of the second lens element.

When using a convex meniscus lens as the first lens element, it is preferred to dispose a full-opened aperture and a movable stop plate between the first lens element and the second lens element, for compensation of aberration. It is also preferred to dispose the shutter blade close to the stop, that is, between the first lens element and the second lens element, for it can prevent unevenness of exposure and increase a shutter speed.

Since the shutter blade is disposed between the first lens element and the second lens element according to the present invention, it is possible to use a space formed in front of a cartridge chamber as a path of the shutter blade, which is not possible for the shutter blade disposed between the second lens element and the third lens element. In addition, it is possible to have a space for disposing a mechanism for driving the shutter blade, since the shutter blade can be disposed near the subject side.

Furthermore, since the movable stop plate is disposed close to the shutter blade such as in front of or behind it, it has an effect to increase the luminance at the edge of image field.

### BRIEF DESCRIPTION OF THE DRAWINGS

One with ordinary skill in the art would easily understand the above-described objects and advantages of the present invention when the following detailed description is read with reference to the drawings attached hereto.

FIG. 1 is a perspective view illustrating a lens-fitted photographic film unit of the present invention;

FIG. 2 is an exploded perspective view illustrating a constitution of a unit body;

FIG. 3 is an exploded perspective view illustrating positional relations between a taking lens, stop plates, and a shutter blade;

FIG. 4 is a cross sectional view illustrating the positional relations between the taking lens, the stop plates, and the shutter blade;

FIG. 5 is an explanatory view illustrating the positional relation between a path of the shutter blade and a cartridge chamber from a viewpoint in the subject side;

FIG. 6 is a cross-sectional view illustrating a basic constitution inside the unit body; and

FIG. 7 is an explanatory view illustrating the positional relation between a cartridge loaded in a cartridge chamber and the taking lens.

### PREFERRED EMBODIMENTS OF THE INVENTION

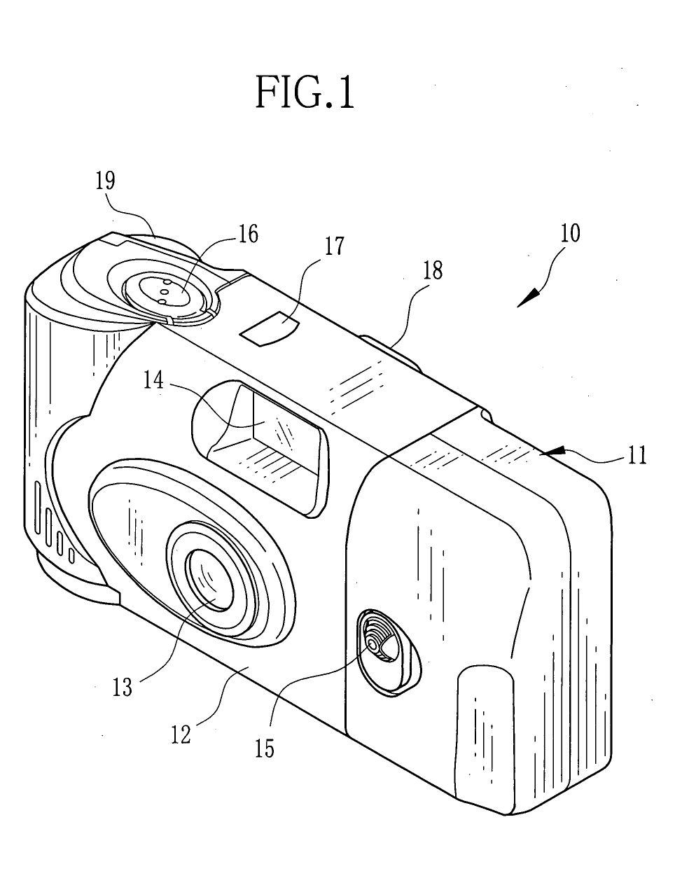

As shown in FIG. 1, a lens-fitted photographic film unit 10 of the present invention comprises a unit body 11 incorporating various photographic mechanisms therein and a label 12 adhered to around the periphery of the unit body 11. The label 12 is provided with openings for exposing various parts of the unit body 11.

The front face of the unit body 11 is provided with a taking lens 13, a front viewfinder window 14, and a stop changeover operating member 15. The top face of the unit body 11 is provided with a shutter release button 16 and a frame counter window 17, while the rear face of the unit body 11 is provided with a rear viewfinder window 18 and exposes a part of a film winding wheel 19 for winding up an exposed photo film after photo taking.

The stop changeover operating member 15 can be set in a first position, a second position or a third position, each of which selects a mode different from one another. The first position selects a small stop mode used for photographing a subject with high luminance such as the one under daylight. The second position selects a medium stop mode used for photographing the subject with medium luminance. The third position selects a full-opened aperture mode used for photographing the subject with low luminance. Note that it is preferred to show the selected mode within the viewfinder window, such that a photographer can know which one of the modes is selected by looking through the rear viewfinder window 18.

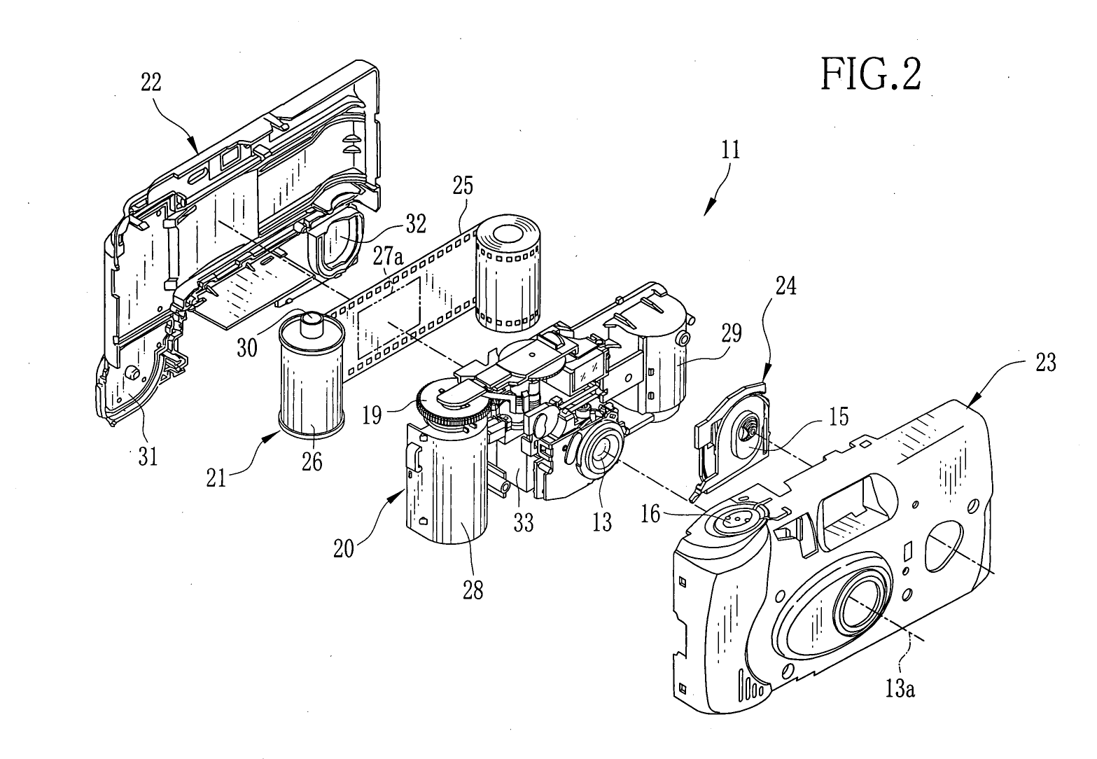

As shown in FIG. 2, the unit body 11 comprises a body base 20, a rear cover 22, and a front cover 23. A photo film cartridge 21 comprises a photo film 25 and a cartridge (a cassette) 26 for containing the photo film 25 and is preloaded in the body base 20. The photo film 25 is of ISO1600. An operating plate 24 with the stop changeover operating member 15 mounted thereon is disposed behind the front cover 23.

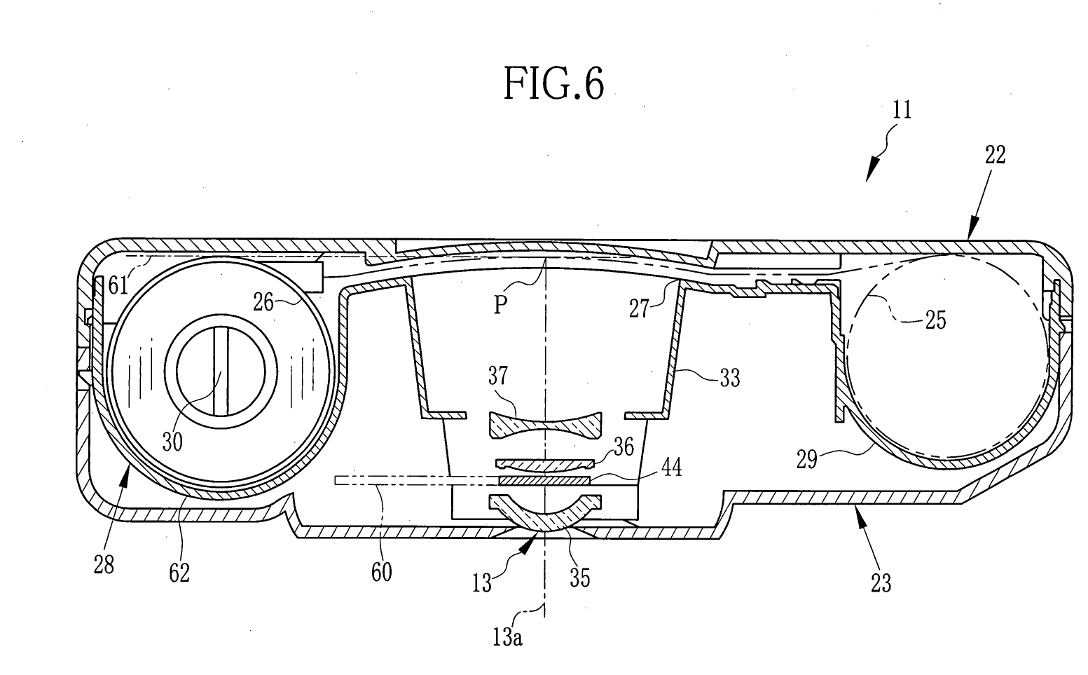

A cartridge chamber (a cassette chamber) 28 for containing the cartridge 26 is integrally formed with the body base 20 to the left side of an exposure aperture 27, while a film chamber 29 for containing a roll of the unexposed photo film 25 drawn from the cartridge 26 is integrally formed with the body base 20 to the right side of the exposure aperture 27 in relation to the subject (see FIG. 6). The film winding wheel 19 is rotatably provided on top of the cartridge chamber 28 and engages with a spool core 30 of the cartridge 26 loaded in the cartridge chamber 28, for feeding the photo film 25 from the film chamber 29 to the cartridge chamber 28 as being rotated in a film-winding direction and winding an exposed picture frame 27a into the cartridge 26.

The rear side of the body base 20 and the bottom sides of both the cartridge chamber 28 and the film chamber 29 are opened. The rear cover 22 is attached to the rear side of the body base 20 after the photo film cartridge 21 is loaded, in order to shield the rear side of the body base 20 in a light-tight manner. The rear cover 22 is provided with bottom lids 31 and 32 of a pull-top type that are thin walls to be bent. The bottom lid 31 covers the bottom of the cartridge chamber 28, while the bottom lid 32 covers the bottom of the film chamber 29. The bottom lid 31 is opened when the cartridge 26 having the exposed photo film therein is removed in a photofinishing laboratory.

A dark box 33 is provided in front of the photo film 25, and the taking lens 13, a shutter mechanism, and a stop changeover mechanism are mounted on the front face of the dark box 33. A finder optical system, a film wind-stopping mechanism, a film counter mechanism, and a shutter charge mechanism are mounted on top of the dark box 33.

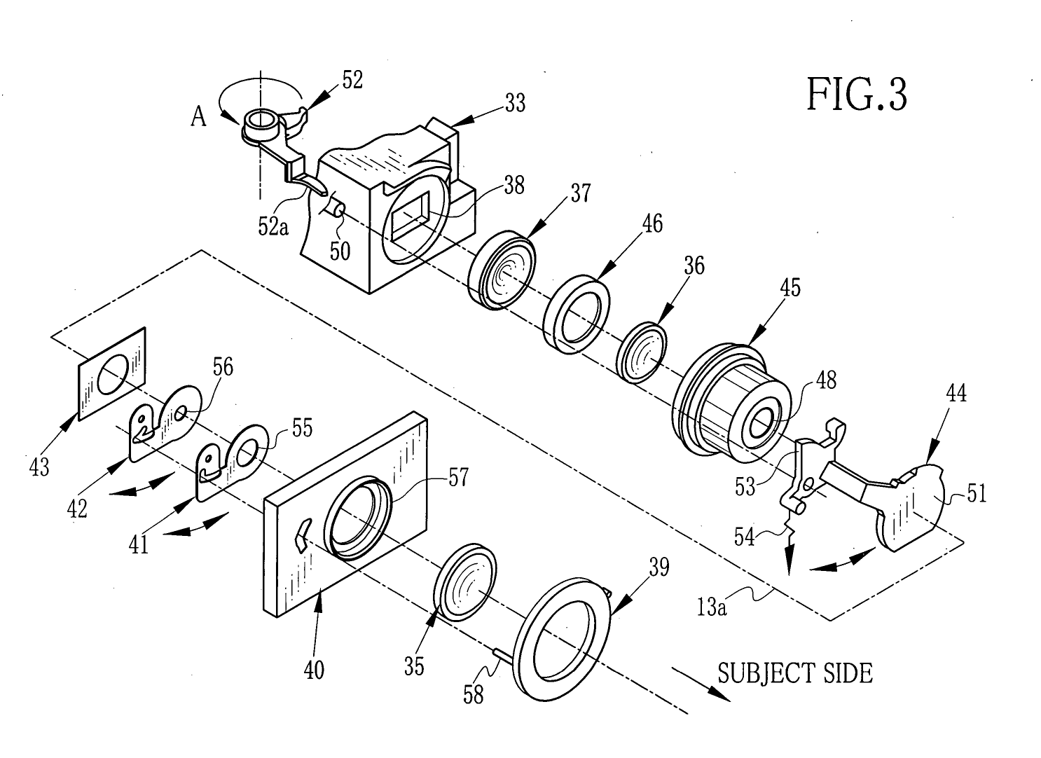

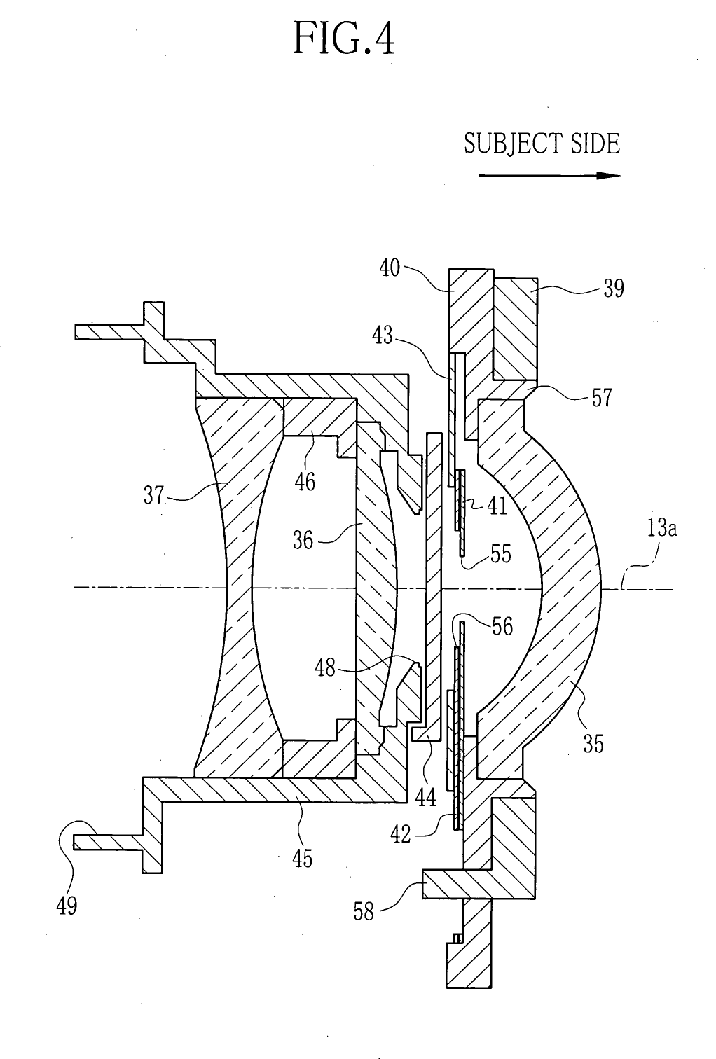

As shown in FIG. 3 and FIG. 4, the taking lens 13 comprises a first lens element 35, a second lens element 36, and a third lens element 37, which are all formed of plastics. The taking lens 13 is formed to have a focal length F of 26 mm or less and f-number of 5.6 or less. The first lens element 35 is a positive meniscus lens and disposed with its aspherical convex face on the subject side. The second lens element 36 is a plane-convex lens and disposed with its convex face on the subject side. The third lens element 37 is a biconcave lens and its face on the subject side has a larger curvature than the other one on a focal-plane side.

An opening 38 is formed on the front face of the dark box 33 to allow the subject light to enter. A cam ring 39, the first lens element 35, a lens holding plate 40, a first stop plate 41, a second stop plate 42, a spacer 43, a shutter blade 44, a lens barrel 45, the second lens element 36, a spacer ring 46, and the third lens element 37 are disposed in front of the dark box 33 from the subject side in the stated order.

The first lens element 35 is supported within the lens holding plate 40. The lens barrel 45 is of a cylindrical shape and provided with a full open-aperture 48 fixed on the front face thereof. The lens barrel 45 is provided with an opening 49 on the rear face thereof, into which the second lens element 36, the spacer ring 46, and the third lens element 37 are inserted in the stated order.

The shutter blade 44 is disposed between the first lens element 35 and the lens barrel 45 to be swingable across a photography optical path around a photography optical axis 13a. The shutter blade has one end engaged with an axis 50 on the dark box 33 and swings such that a light shield portion 51 opens/closes the full-opened aperture 48 (a shutter opening). When a shutter driving lever 52 rotates in the A direction, shown by an arrow in FIG. 3, in response to shutter release, a ledge 53 formed at one end of the shutter blade 44 is kicked by a contact member 52a and the light shield portion 51 is thus moved toward the cartridge chamber 28. After the shutter blade 44 reaches an open position near the cartridge chamber 28 for fully opening the full-opened aperture 48, it is biased by a spring 54 back to a close position for closing the full-opened aperture 48. Accordingly, the shutter blade 44 forms its path in the space between the close position and the open position.

The spacer 43 is disposed behind the lens holding plate 40, and between them the first and the second stop plates 41 and 42 are removably provided. The first stop plate 41 is provided with a medium aperture 55 smaller than the full-opened aperture 48, while the second stop plate 42 is provided with a small aperture 56 smaller than the medium aperture 55.

A fixed barrel 57 is provided on the front face of the lens holding plate 40 for fitting the first lens element 35 therein. The cam ring 39 is rotatably mounted on the periphery of the fixed barrel 57. The cam ring 39 is provided with a pin 58 on the periphery thereof for engaging with each end portion of the first and the second stop plates 41 and 42 in order to insert or remove the first and the second stop plates 41 and 42 into or from the photography optical axis in response to the operation of the stop changeover operating member 15. When the stop changeover operating member 15 is in the first position, the first stop plate 41 is set in a retreat position and the second stop plate 42 is set in an inserted position, and the subject is thus photographed through the small aperture 56 of the second stop plate 42. When the stop changeover operating member 15 is in the second position, the first stop plate 41 is set in the inserted position and the second stop plate 42 is set in the retreat position, and the subject is thus photographed through the medium aperture 55 of the first stop plate 41. When the stop changeover operating member 15 is in the third position, both of the first stop plate 41 and the second stop plate 42 are set in the retreat position, and the subject is thus photographed through the full-opened aperture 48.

The taking lens 13 comprising three lens elements requires a larger space than that comprising two lens elements. In addition, since the taking lens 13 comprising three lens elements has a wider angle, the focal length becomes short. As a result, the third lens element 37 is disposed very close to the focal-plane of the photo film.

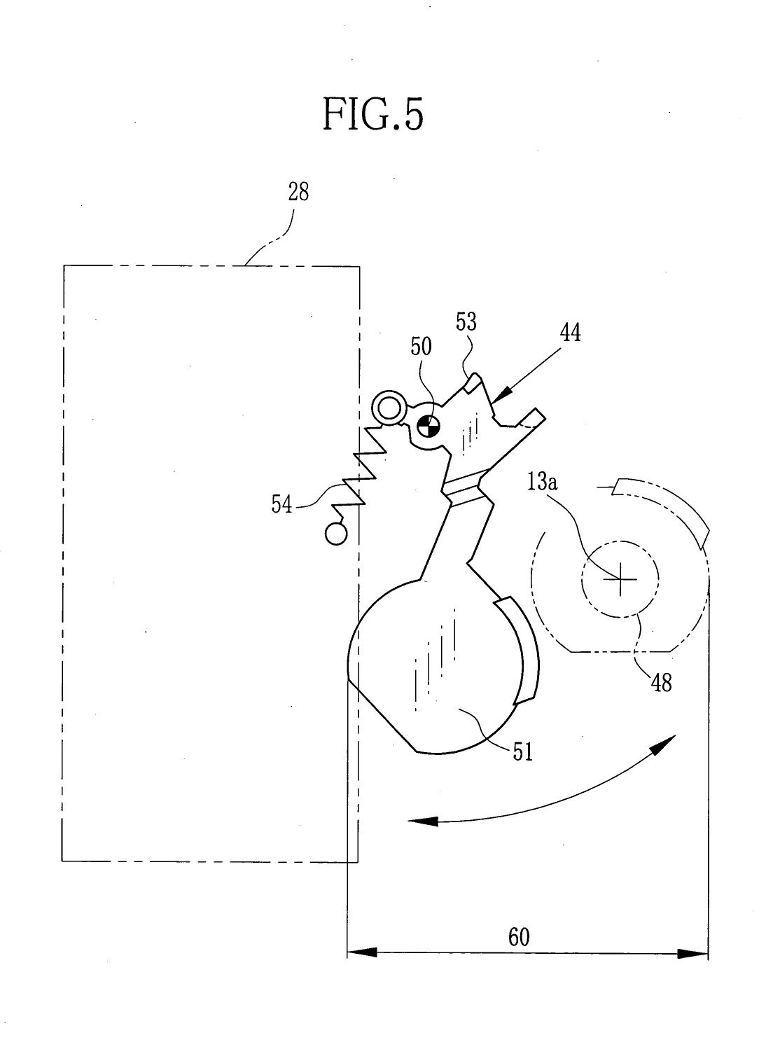

As shown in FIG. 5, the light shield portion 51 of the shutter blade 44 swings between the close position, which is shown by a chain double-dashed line, for blocking the photography optical axis 13a and the open position for opening the full-opened aperture 48 by moving toward the cartridge chamber 28. A path 60 of the light shield portion 51 enters the space formed in front of the cartridge chamber 28.

As shown in FIG. 6, a line 61 is an imaginary line which passes a focal point P of the photography optical axis 13a and is parallel to a film feeding direction. The cartridge 26 is placed with its periphery contacting the subject side of the line 61. A wall of the cartridge chamber 28 forms an approximate U-shape along with the periphery of the cartridge 26. As is clear from FIG. 6, the closer to the first lens element 35 the shutter blade 44 is disposed, the longer space the shutter blade 44 can obtain for its path.

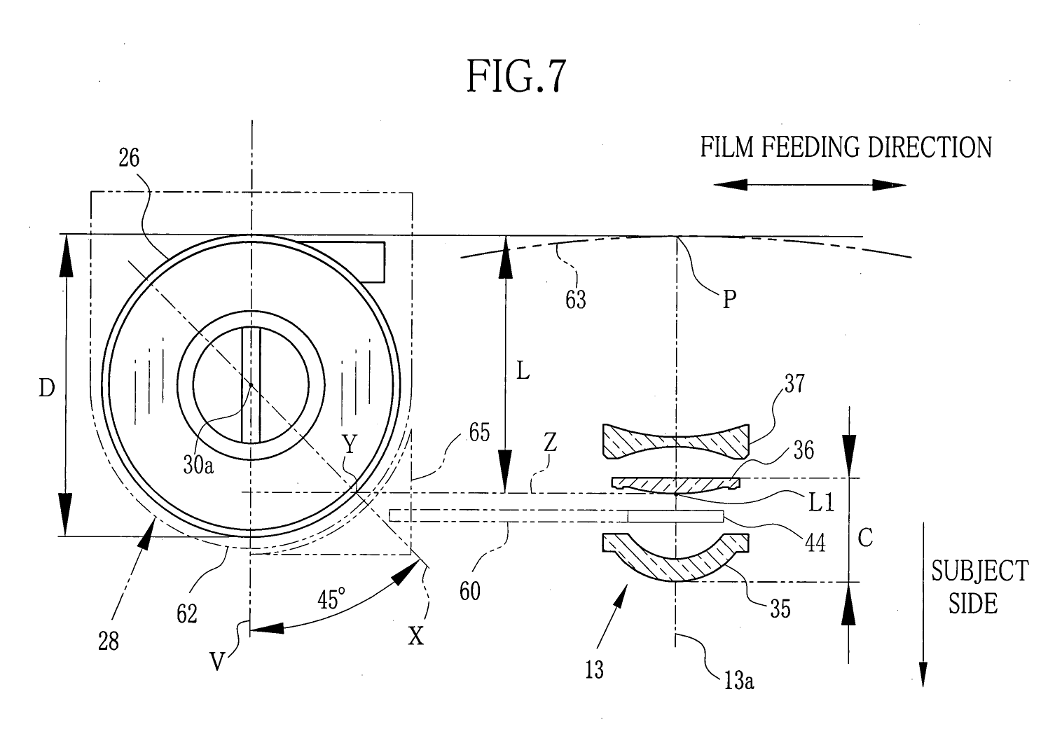

Accordingly, in the present embodiment as shown in FIG. 7, the shutter blade 44 is disposed between the first lens element 35 and the second lens element 36. The taking lens 13 is arranged to satisfy the following conditional expression (1),
L≧((2+\sqrt{2})/4)×D (mm) (1),
provided that L (mm) represents a distance from the focal point P on a focal-plane 63 (film surface) to the front end of the second lens element 36, and D (mm) represents a diameter of the cartridge 26.

A straight line V is parallel to the photography optical axis 13a and passes through a center 30a of the spool core 30 of the cartridge 26. A point Y represents an intersection of a periphery of the photo film cartridge 26 and a line X, which is rotated counterclockwise by 45 degrees about the center 30a from the line V. A point L1 represents an intersection of the photography optical axis 13a and a line Z that intersects the point Y and is parallel to the film feeding direction. The point L1 satisfies the above conditional expression (1), and the front end of the second lens element 36 is disposed on the point L1. Thereby, it is possible to form the path 60 of the same length as the conventional one in a space 65 in front of the periphery 62 of the cartridge chamber 28. For example, for the cartridge containing the photo film of a 135 type, it is preferred to have the L of more than 21.3 mm, as the D is 25 mm. However, if the L is too long, it increases the thickness of a camera body and results in affecting a camera design adversely. It is preferred to arrange the L to be the same length as or shorter than the diameter D of the cartridge 26, that is, D≧L (mm). It is also preferred to arrange the first and the second lens elements 35 and 36 to satisfy 6≧C≧2.6 mm, or more preferably 5≧C≧3 mm, provided that C represents the distance from the front end of the first lens element 35 to the rear end of the second lens element 36.

Since the taking lens 13 of the present embodiment comprises three lens elements in which two convex lenses and one concave lens are disposed from the subject side in the stated order, it is necessary to precisely set relative positions of the second and the third lens elements 36 and 37. The present invention successfully locates each lens in a precise position by disposing the shutter blade 44 between the first lens element 35 and the second lens element 36, securing the second and the third lens elements 36 and 37 within the lens barrel 45, and placing the spacer ring 46 between the second and the third lens elements 36 and 37.

Note that the shutter blade 44 can be disposed not only between the first lens element 35 and the second lens element 36 but also between the second lens element 36 and the third lens element 37. In this case, it is preferred that the full-opened aperture 48, the first stop plate 41, and the second stop plate 42 are disposed between the second lens element 36 and the third lens element 37 while keeping the same positional relations with the shutter blade 44.

In addition, although the taking lens 13 comprises three lens elements in the above embodiment, the taking lens 13 can be comprise two or more than three lens elements. In those cases, it is preferred to dispose the stop plate and the shutter blade 44 between the first lens and the second lens from the subject side.

Furthermore, although the stop mechanism and the shutter mechanism are individually provided in the above embodiment, it is also possible to provide a shutter mechanism with a stop function (a program shutter mechanism) instead, that comprises two shutter blades and can open/close them on the photography optical axis.

Although the present invention has been described with respect to the preferred embodiments, the present invention is not to be limited to the above embodiments but, on the contrary, various modifications will be possible to those skilled in the art without departing from the scope of claims appended hereto.

What is claimed is:

1. A lens-fitted film unit including a cassette chamber for containing a cassette, a film chamber for containing an unexposed photo film drawn from said cassette, and an exposure aperture disposed on a photography light path between said cassette chamber and said film chamber, the front portion of said cassette chamber being formed of a curved wall having a cross section of substantially U-shape, said lens-fitted photographic film unit comprising:
a taking lens for forming a subject image on said photo film in said exposure aperture, said taking lens having a first lens element, a second lens element, and a third lens element being disposed from the subject side in the stated order;
a shutter blade swingable between an open position and a close position; and
a light shield portion provided to said shutter blade, said light shield portion being disposed between said first lens element and said second lens element, for closing said photography light path when said shutter blade being in said close position, and for opening said photography light path by moving in front of said cassette chamber when said shutter blade moving to said open position.

2. A lens-fitted photographic film unit defined in claim 1, wherein the following conditional expressions are satisfied:
L≧((2+\sqrt{2})/4)×D (mm)
C≧3 (mm),
provided that said C (mm) represents a lens distance between the front end of said first lens element and the rear end of said second lens element, said D (mm) represents an outer diameter of said cassette, and said L (mm) represents a distance between said photo film at the center of said exposure aperture and the front end of said second lens element.

3. A lens-fitted photographic film unit defined in claim 2, wherein said lens distance C is less than 5 (mm).

4. A lens-fitted photographic film unit defined in claim 1, further comprising:
a fixed full-opened aperture and at least one stop plate having an aperture smaller than said full-opened aperture, said stop plate being movable into/out of said photography light path between said shutter blade and said first lens element, or between said shutter blade and said full-opened aperture.

5. A lens-fitted photographic film unit defined in claim 1, wherein said first lens element is a positive meniscus lens and disposed with its concave surface on the subject side, said second lens element is a plane-convex lens and disposed with its concave surface on the subject side, and said third lens element is a biconcave lens and disposed with its surface having a larger curvature on the subject side.

6. A lens-fitted photographic film unit defined in claim 5, wherein said second lens element and said third lens element are held in a lens barrel.

7. A lens-fitted photographic film unit defined in claim 6, wherein a spacer is provided between said second lens element and said third lens element.
